(19) United States
(12) Patent Application Publication
(10) Pub. No.: US 2025/0306370 A1
(43) Pub. Date: Oct. 2, 2025

(54) Wireless Virtual Reality Headset Device

(71) Applicant: Jermaine Townes, Wood Dale, IL (US)

(72) Inventor: Jermaine Townes, Wood Dale, IL (US)

(21) Appl. No.: 18/983,520

(22) Filed: Dec. 17, 2024

Related U.S. Application Data
(60) Provisional application No. 63/572,574, filed on Apr. 1, 2024.

(51) Int. Cl. G02B 27/01; A63B 71/06

(52) U.S. Cl. CPC G02B 27/017; A63B 71/0622; G02B 27/0101; A63B 2071/0666; A63B 2220/806; A63B 2220/808; A63B 2225/20; A63B 2225/50; A63B 2230/06; A63B 2230/30; A63B 2230/75; G02B 2027/0138; G02B 2027/014

(57) ABSTRACT

A wireless virtual reality headset device is disclosed that provides users with a device designed to enhance at-home workouts by providing immersive environments and facilitating community connections. The device allows for real-time connections among remote users for joint exercises in both real and virtual locations using online map data. The device also incorporates health metrics displays and motivational features like virtual companions and awards. The device has wireless Wi-Fi and Bluetooth connectivity, high-definition graphics, integrated communication tools, and user comfort and safety features, including durable materials and a removable light shield for clear peripheral vision.

### CROSS-REFERENCE TO RELATED APPLICATION

The present application claims priority to, and the benefit of, U.S. Provisional Application No. 63/572,574, which was filed on Apr. 1, 2024, and is incorporated herein by reference in its entirety.

### FIELD OF THE INVENTION

The present invention relates generally to the field of wireless virtual reality headset devices. More specifically, the present invention relates to a virtual reality headset device that provides new social functionalities and health metrics. Accordingly, this disclosure makes specific reference thereto the present invention. Nonetheless, it is to be appreciated that aspects of the present invention are also equally applicable to other like applications, devices and methods of manufacture.

### BACKGROUND

By way of background, this invention relates to improvements in wireless virtual reality headset devices. Generally, people desire virtual reality devices with increased social functionalities and health metrics. Furthermore, working out at home can get boring and lonely, however connecting to online content can be distracting and interfere with proper form. Thus, a user desires a way to make exercise fun, putting users into immersive virtual reality workouts, making it possible to travel anywhere while safely using treadmills, exercise bikes, rowers, and more.

A virtual reality headset provides an immersive experience to a user viewing images on a display while wearing the headset. A virtual reality headset may block the view of the outside or real world from the user in order to immerse the user in the images presented by the headset. By blocking the view of the outside world, the user's senses are focused on the images, thereby engaging the user in the experience. This can help to make the experience more realistic.

Accordingly, there is a demand for an improved wireless virtual reality headset device that makes exercise fun, putting users into immersive virtual reality worlds, making it possible to travel anywhere while safely using treadmills, exercise bikes, rowers, and more. More particularly, there is a demand for a wireless virtual reality headset device that connects remote users in real time so they can exercise together wherever they choose, including real locations using online map data.

Furthermore, there is a long felt need in the art for a wireless virtual reality headset device that provides users with a wireless virtual reality headset designed for immersive workouts. There is also a long felt need in the art for a wireless virtual reality headset device that makes it possible to travel anywhere while safely using treadmills, exercise bikes, rowers, etc. Further, there is a long felt need in the art for a wireless virtual reality headset device that allows users to exercise together in real time. Moreover, there is a long felt need in the art for a device that allows users to exercise wherever they choose, including real locations using online map data. Further, there is a long felt need in the art for a wireless virtual reality headset device that makes workouts more entertaining. Finally, there is a long felt need in the art for a wireless virtual reality headset device that displays personal health metrics.

The subject matter disclosed and claimed herein, in one embodiment thereof, comprises a wireless virtual reality headset device that provides users with a device designed to enhance at-home workouts by providing immersive environments and facilitating community connections. The device allows for real-time connections among remote users for joint exercises in both real and virtual locations using online map data. The device also incorporates health metrics displays (i.e., heart rate, speed, calories burned, distance, etc.) and motivational features like virtual companions and awards. The device has wireless Wi-Fi and Bluetooth connectivity, high-definition graphics, integrated communication tools (i.e., microphone, wireless earpiece, etc.), and user comfort and safety features, including durable materials and a removable light shield for clear peripheral vision.

In this manner, the wireless virtual reality headset device of the present invention accomplishes all of the forgoing objectives and provides users with a device that provides new social functionalities and health metrics. The device is a virtual reality headset which provides immersive environments while exercising.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a wireless virtual reality headset device that provides users with a device designed to enhance at-home workouts by providing immersive environments and facilitating community connections. The device allows for real-time connections among remote users for joint exercises. The device also incorporates health metrics displays and motivational features like virtual companions and awards. The device has wireless Wi-Fi and Bluetooth connectivity, high-definition graphics, integrated communication tools, and user comfort and safety features, including durable materials and a removable light shield for clear peripheral vision.

In one embodiment, the wireless virtual reality headset device of the present technology is configured to provide an immersive experience, but to also allow a user to enhance at-home workouts. Virtual reality headsets have a wide range of applications including, but not limited to, gaming, workplace, education, and training simulations. Virtual reality makes exercise fun, putting users into immersive virtual reality worlds, making it possible to travel anywhere while safely using treadmills, exercise bikes, rowers, etc.

In one embodiment, the wireless virtual reality headset device comprises a headset component with a processing unit. The processing unit is typically contained within the headset component and includes much of the computing power used to operate the wireless virtual reality headset device. In other embodiments, the processing unit may take various embodiments. In yet other embodiments, the processing unit is a separate unit which may be worn on the user's body, i.e., the wrist or in a pocket. The processing unit may communicate wirelessly (i.e., WiFi, Bluetooth, infrared, RFID transmission, wireless Universal Serial Bus (WUSB), cellular, 3G, 4G or other wireless communication means) over a communication network to one or more hub computing systems whether located nearby or at a remote location. In other embodiments, the functionality of the processing unit may be integrated in the software and hardware components of the wireless virtual reality headset device.

In one embodiment, the headset component is worn on the head of a user so that the user can see the display while blocking out the real world. The adjustable straps allow the headset component to fit securely to the user's head. In one embodiment, the adjustable straps are secured to a cushioning component, which secures to the back of a user's head. The cushioning component helps to secure the headset component to a user's head and provides a more comfortable fit for the device. In one embodiment, the cushioning component comprises an adjustment knob for securing the device to a user's head. Generally, the adjustable straps, the cushioning component and the headset component comprise silicone cushions for comfort and fit.

In one embodiment, the headset component comprises a front facing side, a rear facing side, opposing side ends, and opposing top and bottom sides. In some embodiments, the headset component is made of plastic, or at least primarily of plastic. The opposing side ends and opposing top and bottom ends, each of which adjoin the front facing and rear facing sides. The front facing side faces the direction in which the user naturally looks when wearing the wireless virtual reality headset device.

In one embodiment, the headset component aids in providing an immersive experience by blocking the user's view of the world outside of the wireless virtual reality headset device, at least most of the time. Specifically, the rear facing side is configured to curve around the user's eyes and block peripheral vision. Typically, the rear facing side curves inward or is concave to a user's face. Edges of the rear facing side may be placed against the user's face, such that the user's view of the world outside of the wireless virtual reality headset device may be blocked. Thus, the headset component is configured to provide a shield between the outer edges of the display and the user's face to block the world outside of the wireless virtual reality headset device.

In one embodiment, the device comprises a removable light shield component which provides for clear peripheral vision for safety while exercising with the device. The removable light shield component removably secures to the bottom of the headset component during use and can be removed, as needed.

In one embodiment, the front facing side comprises a virtual reality display. Thus, the front facing side serves as a base into which the display is mounted. The display can be formed from one single physical display screen or two separate screens. A variety of technologies may be used to implement the display. In one embodiment, the display is an LCD screen (or two LCD screens for stereoscopic vision) and high-definition graphics. In another embodiment, the front facing side comprises pancake lenses or any other suitable lenses, such as Fresnel lenses, etc., as is known in the art.

In one embodiment, the headset component comprises a camera. The camera could be an RGB camera, IR camera, etc. In one embodiment, the headset component comprises an audio microphone. Thus, the wireless virtual reality headset device can be controlled in response to the user's voice. Further, the microphone allows users to chat with each other while exercising together. The microphone is typically located on the front facing side but can be positioned in any suitable place on the headset component. In one embodiment, the headset component comprises at least one headphone jack for wireless headphones/earpiece. In one embodiment, the headset component comprises built-in speakers on each side. Accordingly, the device comprises multiple integrated communication tools for controlling the device during use and enhancing the workouts and exercise experience.

In one embodiment, the processing unit comprises software and hardware components which receive data from the wireless virtual reality headset device and may also receive sensory information from a computing system over a network. Based on that information, the processing unit will determine where and when to provide a virtual image to the user and send instructions accordingly to the control circuitry of the wireless virtual reality headset device.

In one embodiment, the headset component comprises health metrics and tracking and is used to track and display one or more health metrics of the user while using the device, such as heart rate, blood pressure, speed, calories burned, distance traveled, etc.

In one embodiment, the device comprises motivational features, such as working out alongside virtual companions/characters and earning awards for completing workouts at preset points. Further, the device allows for real-time connections among remote users for joint exercises in both real and virtual locations using online map data. Thus, the device makes workouts feel more entertaining, letting users row, bike, and run in exciting environments, such as virtual whitewater rapids, mountain bike trails, urban running paths, etc.

In one embodiment, the processing unit includes a wireless communication component which can include a Wi-Fi enabled communication device, Bluetooth communication device, infrared communication device, cellular, 3G, 4G communication devices, wireless USB (WUSB) communication device, RFID communication device etc. The wireless communication component thus allows peer-to-peer data transfers with for example, another system, as well as connection to a larger network via a wireless router or cell tower.

In yet another embodiment, the wireless virtual reality headset device comprises a plurality of indicia.

In yet another embodiment, a method of enhancing at-home workouts by providing immersive environments and facilitating community connections is disclosed. The method includes the steps of providing a wireless virtual reality headset device comprising a headset component and attached cushioning component. The method also comprises positioning the headset component and cushioning component over a user's head. Further, the method comprises performing workouts with remote users in both real and virtual locations. Finally, the method comprises displaying health metrics and motivational features.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the wireless virtual reality headset device of the present invention in accordance with the disclosed architecture;

FIG. 2 illustrates a front perspective view of one embodiment of the wireless virtual reality headset device of the present invention showing the camera and built-in microphone in accordance with the disclosed architecture;

FIG. 3 illustrates a side perspective view of one embodiment of the wireless virtual reality headset device of the present invention showing the arms and built-in speakers in accordance with the disclosed architecture;

FIG. 4 illustrates a top perspective view of one embodiment of the wireless virtual reality headset device of the present invention showing the silicone cushions in accordance with the disclosed architecture;

FIG. 5 illustrates a perspective view of one embodiment of the wireless virtual reality headset device of the present invention showing the removable bottom light shield in accordance with the disclosed architecture;

FIGS. 6A-B illustrates a perspective view of one embodiment of the wireless virtual reality headset device of the present invention in use in accordance with the disclosed architecture;

FIGS. 7A-C illustrates a perspective view of one embodiment of the wireless virtual reality headset device of the present invention showing the durable design of the headset in accordance with the disclosed architecture; and

FIG. 8 illustrates a flowchart showing the method of enhancing at-home workouts by providing immersive environments and facilitating community connections in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a wireless virtual reality headset device that provides users with a wireless virtual reality headset designed for immersive workouts. There is also a long felt need in the art for a wireless virtual reality headset device that makes it possible to travel anywhere while safely using treadmills, exercise bikes, rowers, etc. Further, there is a long felt need in the art for a wireless virtual reality headset device that allows users to exercise together in real time. Moreover, there is a long felt need in the art for a device that allows users to exercise wherever they choose, including real locations using online map data. Further, there is a long felt need in the art for a wireless virtual reality headset device that makes workouts more entertaining. Finally, there is a long felt need in the art for a wireless virtual reality headset device that displays personal health metrics.

The present invention, in one exemplary embodiment, is a novel wireless virtual reality headset device that provides users with a device designed to enhance at-home workouts by providing immersive environments and facilitating community connections. The device allows for real-time connections among remote users for joint exercises in both real and virtual locations using online map data. The device also incorporates health metrics displays (i.e., heart rate, speed, calories burned, distance, etc.) and motivational features like virtual companions and awards. The device has wireless Wi-Fi and Bluetooth connectivity, high-definition graphics, integrated communication tools (i.e., microphone, wireless earpiece, etc.), and user comfort and safety features, including durable materials and a removable light shield for clear peripheral vision. The present invention also includes a novel method of enhancing at-home workouts by providing immersive environments and facilitating community connections. The method includes the steps of providing a wireless virtual reality headset device comprising a headset component and attached cushioning component. The method also comprises positioning the headset component and cushioning component over a user's head. Further, the method comprises performing workouts with remote users in both real and virtual locations. Finally, the method comprises displaying health metrics and motivational features.

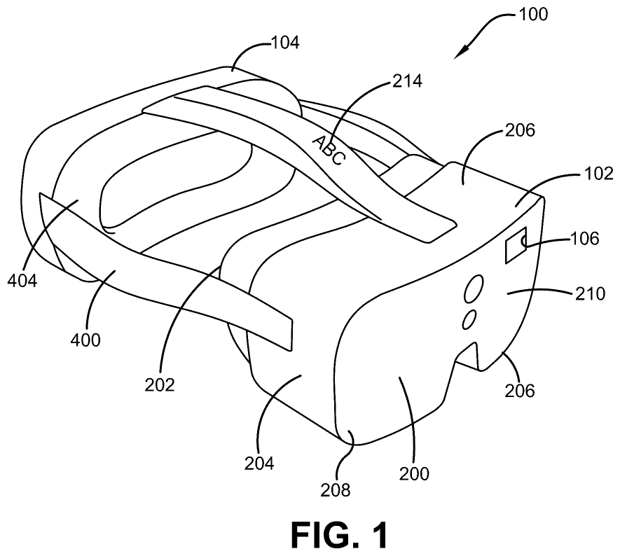

Referring initially to the drawings, FIG. 1 illustrates a perspective view of one embodiment of the wireless virtual reality headset device 100 of the present invention. In the present embodiment, the wireless virtual reality headset device 100 is an improved wireless virtual reality headset device 100 that provides a user with a virtual reality device that enhances at-home workouts. Specifically, the wireless virtual reality headset device 100 comprises a headset component 102 and attached cushioning component 104. The device 100 allows for real-time connections among remote users for joint exercises. The device 100 also incorporates health metrics displays and motivational features like virtual companions and awards. The device 100 has wireless Wi-Fi and Bluetooth connectivity, high-definition graphics, integrated communication tools, and user comfort and safety features.

Generally, the wireless virtual reality headset device 100 of the present technology is configured to provide an immersive experience, but to also allow a user to enhance at-home workouts. Virtual reality headsets have a wide range of applications including, but not limited to, gaming, workplace, education, and training simulations. Virtual reality makes exercise fun, putting users into immersive virtual reality worlds, making it possible to travel anywhere while safely using treadmills, exercise bikes, rowers, etc.

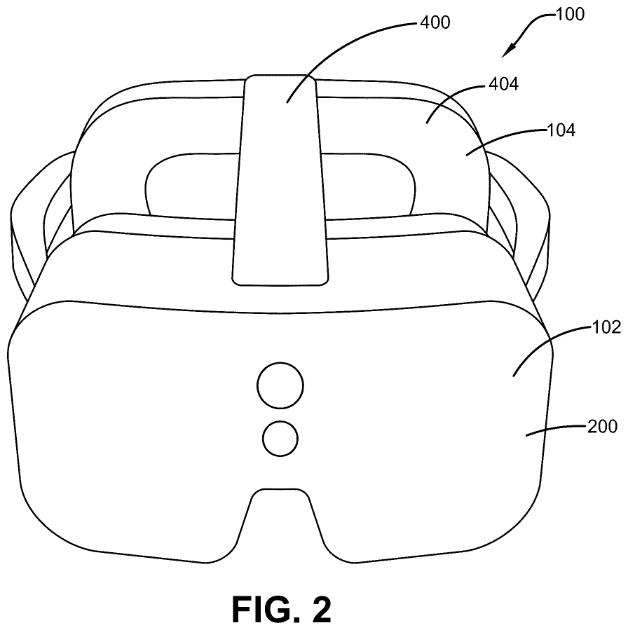

As shown in FIG. 2, the wireless virtual reality headset device 100 comprises a headset component 102 with a processing unit 106. The processing unit 106 is typically contained within the headset component 102 and includes much of the computing power used to operate the wireless virtual reality headset device 100. In other embodiments, the processing unit 106 may take various embodiments. In yet other embodiments, the processing unit 106 is a separate unit which may be worn on the user's body, i.e., the wrist or in a pocket. The processing unit 106 may communicate wirelessly (i.e., WiFi, Bluetooth, infrared, RFID transmission, wireless Universal Serial Bus (WUSB), cellular, 3G, 4G or other wireless communication means) over a communication network to one or more hub computing systems whether located nearby or at a remote location. In other embodiments, the functionality of the processing unit 106 may be integrated in the software and hardware components of the wireless virtual reality headset device 100.

Furthermore, the headset component 102 comprises a front facing side 200, a rear facing side 202, opposing side ends 204, and opposing top and bottom sides 206. In some embodiments, the headset component 102 is made of plastic, or at least primarily of plastic. The opposing side ends 204 and opposing top and bottom ends 206, each of which adjoin the front facing 200 and rear facing 202 sides. The front facing side 200 faces the direction in which the user naturally looks when wearing the wireless virtual reality headset device 100.

Additionally, the headset component 102 aids in providing an immersive experience by blocking the user's view of the world outside of the wireless virtual reality headset device 100, at least most of the time. Specifically, the rear facing side 202 is configured to curve around the user's eyes and block peripheral vision. Typically, the rear facing side 202 curves inward or is concave to a user's face. Edges 208 of the rear facing side 202 may be placed against the user's face, such that the user's view of the world outside of the wireless virtual reality headset device 100 may be blocked. Thus, the headset component 102 is configured to provide a shield between the outer edges 208 of the display 210 and the user's face to block the world outside of the wireless virtual reality headset device 100.

Further, the front facing side 200 comprises a virtual reality display 210. Thus, the front facing side 200 serves as a base into which the display 210 is mounted. The display 210 can be formed from one single physical display screen or two separate screens. A variety of technologies may be used to implement the display 210. In one embodiment, the display 210 is an LCD screen (or two LCD screens for stereoscopic vision) and high-definition graphics. In another embodiment, the front facing side 200 comprises pancake lenses 212 or any other suitable lenses, such as Fresnel lenses, etc., as is known in the art.

In yet another embodiment, the wireless virtual reality headset device 100 comprises a plurality of indicia 214. The headset component 102 of the device 100 may include advertising, a trademark, or other letters, designs, or characters, printed, painted, stamped, or integrated into the headset component 102, or any other indicia 214 as is known in the art. Specifically, any suitable indicia 214 as is known in the art can be included, such as but not limited to, patterns, logos, emblems, images, symbols, designs, letters, words, characters, animals, advertisements, brands, etc., that may or may not be virtual reality, workout, or brand related.

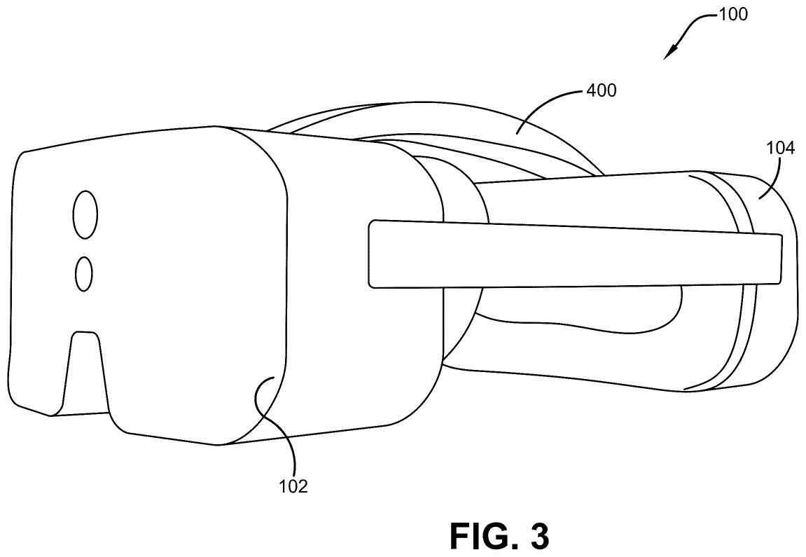

As shown in FIG. 3, the processing unit 106 comprises software and hardware components which receive data from the wireless virtual reality headset device 100 and may also receive sensory information from a computing system over a network. Based on that information, the processing unit 106 will determine where and when to provide a virtual image to the user and send instructions accordingly to the control circuitry of the wireless virtual reality headset device 100.

Further, the processing unit 106 includes a wireless communication component 300 which can include a Wi-Fi enabled communication device, Bluetooth communication device, infrared communication device, cellular, 3G, 4G communication devices, wireless USB (WUSB) communication device, RFID communication device etc. The wireless communication component 300 thus allows peer-to-peer data transfers with for example, another system, as well as connection to a larger network via a wireless router or cell tower.

Additionally, the headset component 102 comprises health metrics 302 and tracking and is used to track and display one or more health metrics 302 of the user while using the device 100, such as heart rate, blood pressure, speed, calories burned, distance traveled, etc., any suitable health metrics 302 can be tracked and displayed as is known in the art, depending on the needs and/or wants of a user.

Furthermore, the device 100 comprises motivational features 304, such as working out alongside virtual companions/characters and earning awards for completing workouts at preset points. Further, the device 100 allows for real-time connections among remote users for joint exercises in both real and virtual locations using online map data. Thus, the device 100 makes workouts feel more entertaining, letting users row, bike, and run in exciting environments, such as virtual whitewater rapids, mountain bike trails, urban running paths, etc., or any other suitable environments as is known in the art, depending on the needs and/or wants of a user.

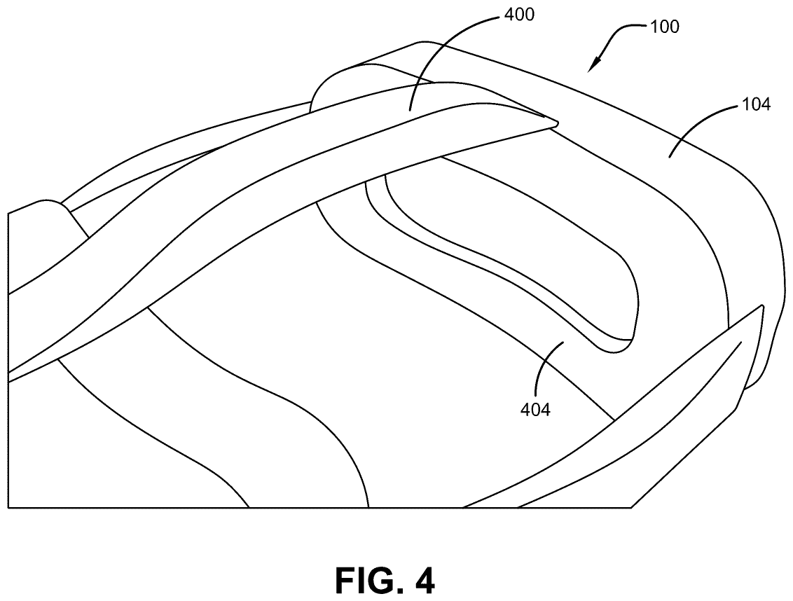

As shown in FIG. 4, the headset component 102 is worn on the head of a user so that the user can see the display 210 while blocking out the real world. The adjustable straps 400 allow the headset component 102 to fit securely to the user's head. In one embodiment, the adjustable straps 400 are secured to a cushioning component 104, which secures to the back of a user's head. The cushioning component 104 helps to secure the headset component 102 to a user's head and provides a more comfortable fit for the device 100. In one embodiment, the cushioning component 104 comprises an adjustment knob 402 for securing the device 100 to a user's head and adjusting the cushioning component 104. Generally, the adjustable straps 400, the cushioning component 104 and the headset component 102 comprise silicone cushions 404 for comfort and fit.

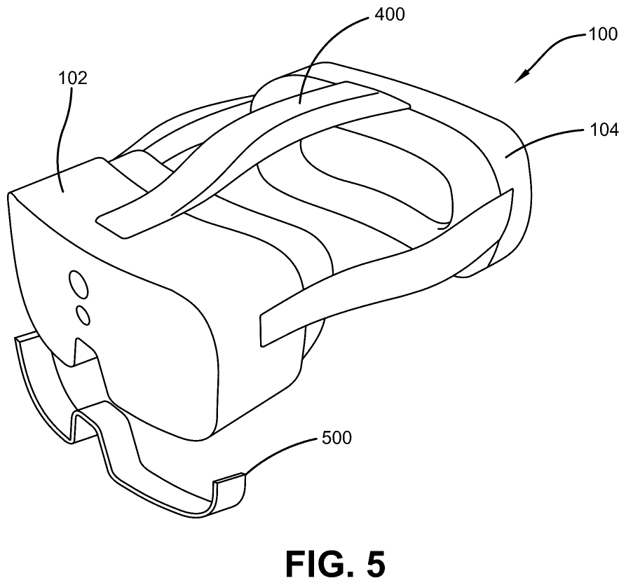

As shown in FIG. 5, the device 100 comprises a removable light shield component 500 which provides for clear peripheral vision for safety while exercising with the device 100. The removable light shield component 500 removably secures to the bottom of the headset component 102 during use and can be removed, as needed.

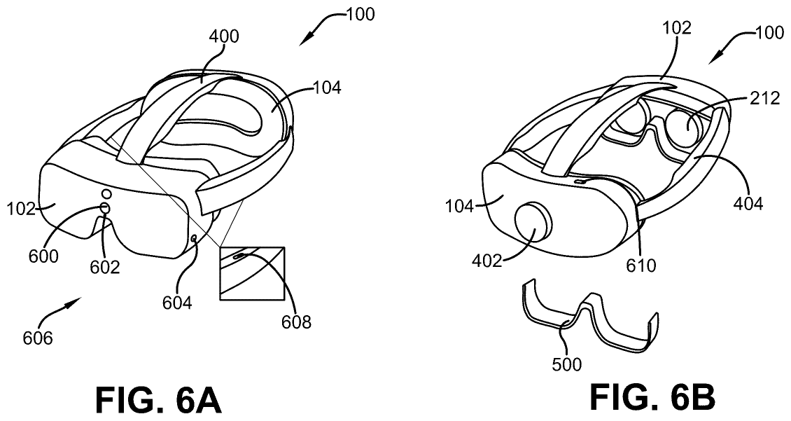

A shown in FIGS. 6A-B and 7A-C, the headset component 102 comprises a camera 600. The camera 600 could be an RGB camera, IR camera, etc. In one embodiment, the headset component 102 comprises an audio microphone 602. Thus, the wireless virtual reality headset device 100 can be controlled in response to the user's voice. Further, the microphone 602 allows users to chat with each other while exercising together. The microphone 602 is typically located on the front facing side 200 but can be positioned in any suitable place on the headset component 102. In one embodiment, the headset component 102 comprises at least one headphone jack 604 for wireless headphones/earpiece 606. The wireless headphones 606 allow users to workout and communicate with remote users. In one embodiment, the headset component 102 comprises built-in speakers 608 on each side. The speakers 608 allow the device 100 to provide an immersive environment for the workouts. Further, the headset component 102 comprises a USBC charging port 610 for charging the device 100, as needed. Accordingly, the device 100 comprises multiple integrated communication tools for controlling the device 100 during use and enhancing the workouts and exercise experience.

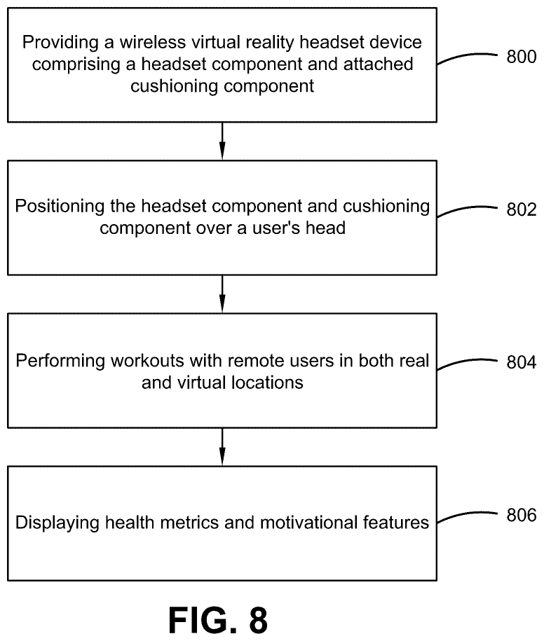

FIG. 8 illustrates a flowchart of the method of enhancing at-home workouts by providing immersive environments and facilitating community connections. The method includes the steps of at 800, providing a wireless virtual reality headset device comprising a headset component and attached cushioning component. The method also comprises at 802, positioning the headset component and cushioning component over a user's head. Further, the method comprises at 804, performing workouts with remote users in both real and virtual locations. Finally, the method comprises at 806, displaying health metrics and motivational features.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “wireless virtual reality headset device”, “virtual reality headset device”, “headset device”, and “device” are interchangeable and refer to the virtual reality headset device 100 of the present invention.

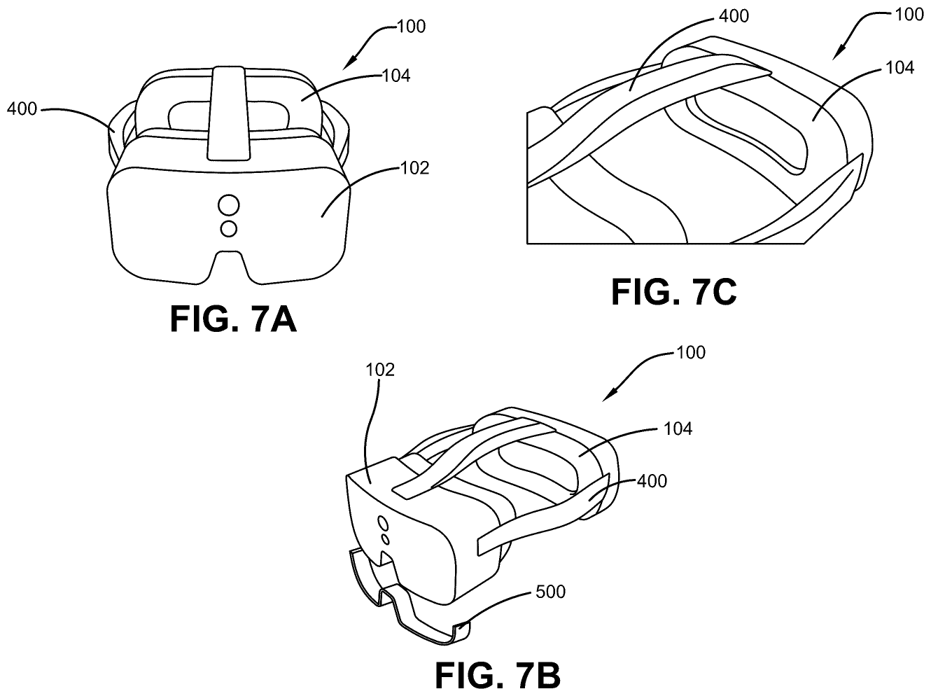

Notwithstanding the forgoing, the wireless virtual reality headset device 100 of the present invention can be of any suitable size and configuration as is known in the art without affecting the overall concept of the invention, provided that it accomplishes the above stated objectives. One of ordinary skill in the art will appreciate that the wireless virtual reality headset device 100 as shown in FIGS. 1-8 is for illustrative purposes only, and that many other sizes and shapes of the wireless virtual reality headset device 100 are well within the scope of the present disclosure. Although the dimensions of the wireless virtual reality headset device 100 are important design parameters for user convenience, the wireless virtual reality headset device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A wireless virtual reality headset device that provides a user with a virtual reality device for enhancing at-home workouts, the wireless virtual reality headset device comprising:
a headset component; and
a cushioning component;
wherein the headset component and the cushioning component are secured together and adapted to be placed on a user's head; and
further wherein the headset component is configured to provide an immersive experience to enhance at-home workouts.

2. The wireless virtual reality headset device of claim 1, wherein the headset component includes a processing unit which includes computing power used to operate the wireless virtual reality headset device.

3. The wireless virtual reality headset device of claim 2, wherein functionality of the processing unit may be integrated in software and hardware components of the wireless virtual reality headset device.

4. The wireless virtual reality headset device of claim 3, wherein the headset component comprises a front facing side, a rear facing side, opposing side ends, and opposing top and bottom sides.

5. The wireless virtual reality headset device of claim 4, wherein the rear facing side is configured to curve around a user's eyes and block peripheral vision, providing an immersive experience by blocking user's view of world outside of the wireless virtual reality headset device.

6. The wireless virtual reality headset device of claim 5, wherein the front facing side comprises a virtual reality display.

7. The wireless virtual reality headset device of claim 6, wherein the front facing side comprises pancake lenses.

8. The wireless virtual reality headset device of claim 7 further comprising a plurality of indicia.

9. The wireless virtual reality headset device of claim 8, wherein the processing unit includes a wireless communication component which can include a Wi-Fi enabled communication device, Bluetooth communication device, infrared communication device, cellular, 3G, 4G communication devices, wireless USB (WUSB) communication device, or RFID communication device.

10. The wireless virtual reality headset device of claim 9, wherein the headset component comprises and displays health metrics, such as heart rate, blood pressure, speed, calories burned, or distance traveled.

11. The wireless virtual reality headset device of claim 10, wherein the wireless virtual reality headset device comprises motivational features, such as working out alongside virtual companions and earning awards for completing workouts at preset points.

12. The wireless virtual reality headset device of claim 11, wherein the headset component comprises adjustable straps secured to the cushioning component and an adjustment knob for securing the wireless virtual reality headset device to a user's head.

13. The wireless virtual reality headset device of claim 12, wherein the headset component comprises a removable light shield component which provides for clear peripheral vision for safety while exercising with the wireless virtual reality headset device.

14. A wireless virtual reality headset device that provides a user with a virtual reality device for enhancing at-home workouts, the wireless virtual reality headset device comprising:
a headset component comprising a front facing side, a rear facing side, opposing side ends, and opposing top and bottom sides; and
a cushioning component;
wherein the headset component and the cushioning component are secured together and adapted to be placed on a user's head;
wherein the headset component comprises adjustable straps secured to the cushioning component and an adjustment knob for securing the wireless virtual reality headset device to a user's head;
wherein the rear facing side is configured to curve around a user's eyes and block peripheral vision, providing an immersive experience by blocking user's view of world outside of the wireless virtual reality headset device;
wherein the front facing side comprises pancake lenses;
wherein the headset component includes a processing unit which includes computing power used to operate the wireless virtual reality headset device;
wherein functionality of the processing unit may be integrated in software and hardware components of the wireless virtual reality headset device;
wherein the processing unit includes a wireless communication component which can include a Wi-Fi enabled communication device, Bluetooth communication device, infrared communication device, cellular, 3G, 4G communication devices, wireless USB (WUSB) communication device, or RFID communication device;
wherein the headset component is configured to provide an immersive experience to enhance at-home workouts;
wherein the headset component comprises and displays health metrics, such as heart rate, blood pressure, speed, calories burned, or distance traveled; and
further wherein the wireless virtual reality headset device comprises motivational features, such as working out alongside virtual companions and earning awards for completing workouts at preset points.

15. The wireless virtual reality headset device of claim 14 further comprising a camera.

16. The wireless virtual reality headset device of claim 14 further comprising a microphone for speaking with each other while exercising together.

17. The wireless virtual reality headset device of claim 14 further comprising at least one headphone jack for wireless headphones or earpieces.

18. The wireless virtual reality headset device of claim 14 further comprising built-in speakers on each side of the headset component.

19. The wireless virtual reality headset device of claim 14 further comprising a USBC charging port for charging the wireless virtual reality headset device, as needed.

20. A method of enhancing at-home workouts by providing immersive environments and facilitating community connections, the method comprising the following steps:
providing a wireless virtual reality headset device comprising a headset component and attached cushioning component;
positioning the headset component and cushioning component over a user's head;
performing workouts with remote users in both real and virtual locations; and
displaying health metrics and motivational features.
